(19) United States
(12) Patent Application Publication
(10) Pub. No.: US 2026/0348459 A1
(43) Pub. Date: Nov. 5, 2026

(54) BALL SCREW LOCKING DEVICE AND BALL SCREW

(71) Applicant: SUZHOU UIGREEN MICRO&NANO TECHNOLOGY CO., LTD., Suzhou (CN)

(72) Inventors: Xiaochen QIAN, Suzhou (CN); Hongyi CAI, Suzhou (CN); Zhensong LU, Suzhou (CN)

(21) Appl. No.: 19/486,679

(22) PCT Filed: Dec. 30, 2023
(86) PCT No.: PCT/CN2023/143156

§ 371 Date: Nov. 21, 2025

(51) Int. Cl. F16H 25/24; F16H 25/22

(52) U.S. Cl. CPC F16H 25/2454; F16H 25/2204

(57) ABSTRACT

Disclosed is a ball screw locking device, including: a base, wherein a mounting groove is arranged on the upper surface of the base, and the base is mounted on a lower connecting member connected to the screw; a support rod, one end of which is rotatably disposed within the mounting groove, wherein an elastic member is disposed between the support rod and the bottom surface of the mounting groove, said elastic member forcing the other end of the support rod to extend from the upper end surface of said base; ball-head plunger, mounted at the end of the support rod extending from the upper end surface of said base, wherein the ball at the top of the ball-head plunger generates upward supporting force through a plunger spring, said ball engaging into the locking groove on the lower end surface of the upper connecting member connected to the nut.

### TECHNICAL FIELD

The present invention relates to a ball screw locking device and ball screw.

### BACKGROUND

A ball screw is a high-precision transmission device, as shown in FIG. 1, which consists of a screw 20′, a nut 10′ and rolling balls, wherein rolling friction spiral is used to replace sliding friction spiral, having advantages of high transmission efficiency, smooth transmission, low wear, long service life, and high precision. Therefore, ball screws are widely applied in various industrial equipment and precision instruments. However, the ball screws on the market are not provided with self-locking devices and cannot achieve locking and positioning, when the nut 10′ reaches a designated position during use, which will cause a reverse rotation phenomenon and lead to safety issues.

### SUMMARY

### Technical Question

To overcome the above disadvantages, the object of the present invention is to provide a ball screw locking device and ball screw that can prevent reverse rotation and ensure transmission safety.

### Technical Solution

In order to overcome the above disadvantages, an object of the present invention is to provide a ball screw locking device and a ball screw that can prevent rotation and ensure transmission safety.

In order to achieve the above object, one of the technical solutions adopted by the present invention is: a ball screw locking device, including: a base, a mounting groove being provided on an upper surface of the base, and the base being mounted on a lower connecting member connected to a screw; a support rod, one end of which is rotatably arranged within the mounting groove, elastic members being arranged between the support rod and a bottom surface of the mounting groove, the elastic members forcing the other end of the support rod to project out of an upper end surface of said base; a ball-head plunger, mounted at the end of the support rod that projects out of the upper end surface of the base, wherein a ball on the top of the ball-head plunger generates an upward supporting force through a plunger spring, and the ball s engaged into a locking groove formed on a lower end surface of an upper connecting member connected with a nut.

Preferably, the elastic member is at least one spring.

Preferably, positioning grooves are respectively provided on end surfaces of the support rod and mounting groove corresponding to each other, and upper and lower ends of the elastic member are respectively engaged in the corresponding positioning grooves.

Preferably, a notch is formed at a bottom portion of the mounting groove adjacent to the ball screw, and the ball-head plunger is movable within the notch.

To achieve the above objectives, another technical solution adopted by the present invention is: a ball screw, comprising a nut and a screw, wherein a plurality of rolling balls are arranged between the nut and the screw, an upper connecting member is provided on an upper end surface of the nut, a lower connecting member is connected to an outer side of the screw, a ball locking device as described above is arranged between the upper connecting member and the lower connecting member, multiple sets of locking grooves are provided on a lower end surface of the upper connecting member, the multiple sets of locking grooves being distributed along the circumference of the lower surface of the upper connecting member, and a ball at the top of the ball-head plunger is engageable into any one of the locking grooves.

Preferably, a handle is provided on the upper end surface of the upper connecting member to facilitate rotation of the nut by an operator.

Preferably, only one ball locking device is provided, the lower connecting member being rectangular, a limiting groove being provided on the upper end surface of one corner of the lower connecting member, and the base of the ball locking device being fixedly fastened in the limiting groove by means of a screw bolt.

### Beneficial Effects

The beneficial effects of the ball screw locking device and ball screw according to the present invention are that the ball screw locking device is configured in a modular arrangement, providing convenient and rapid installation. By incorporating a ball screw locking device onto the ball screw, when the nut reaches a designated position, the ball-head plunger contacts the upper connecting member and generates supporting force through its internal spring, cooperating with the locking groove of the upper connecting member to achieve a stopping function, thereby enabling locking and positioning while preventing reverse rotation of the ball screw. Employing a rolling friction spiral configuration, the system is characterized by high transmission efficiency, smooth transmission, minimal wear, extended service life, and high precision. The structure is stable and simple, thereby improving the reliability and safety of ball screw operation and resolving the inherent problem that ball screws cannot achieve self-locking.

### BRIEF DESCRIPTION OF THE DRAWINGS

FIG. 1 is a perspective view of a ball screw according to prior art;

FIG. 2 is a perspective view of Embodiment 1 viewed from a first angle;

FIG. 3 is a perspective view of Embodiment 1 viewed from a second angle;

FIG. 4 is an exploded view of Embodiment 1;

FIG. 5 is a perspective view of Embodiment 2;

FIG. 6 is a front view of Embodiment 2;

FIG. 7 is a perspective view of a lower end surface of the upper connecting member in Embodiment 2.

### DRAWINGS

10′, nut; 20′, screw; 10, nut; 11, upper connecting member; 12, locking groove; 13, handle; 21, lower connecting member; 22, limiting groove; 23, screw bolt; 30, ball screw locking device; 31, base; 32, mounting groove; 33, elastic member; 34, ball-head plunger; 34a, ball; 35, positioning groove; 36, notch; 37, positioning pin; 38, support rod.

### DETAILED DESCRIPTION

The preferred embodiments of the present invention will be described in detail below with reference to the accompanying drawings, so that the advantages and features of the present invention can be more easily understood by those skilled in the art, thereby making a clearer and more definite definition of the protection scope of the present invention.

### EMBODIMENT

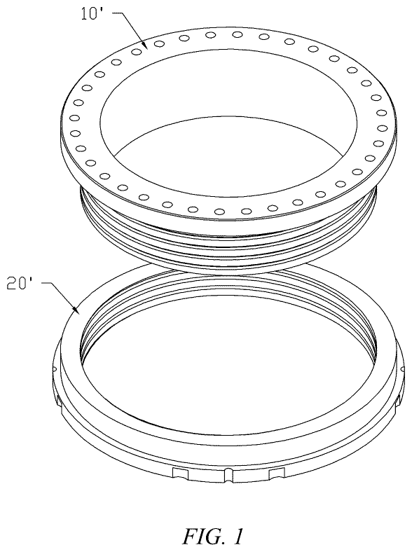

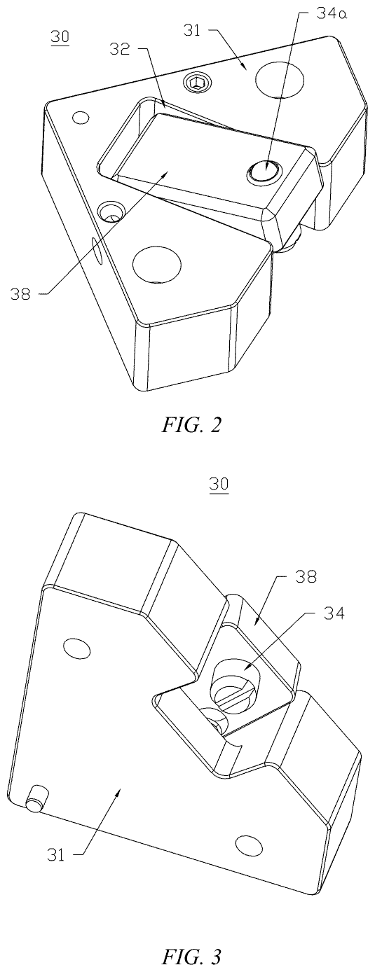

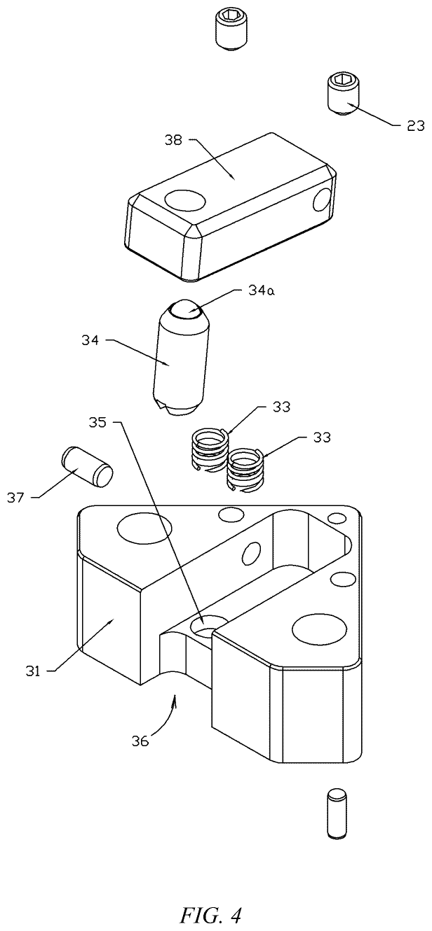

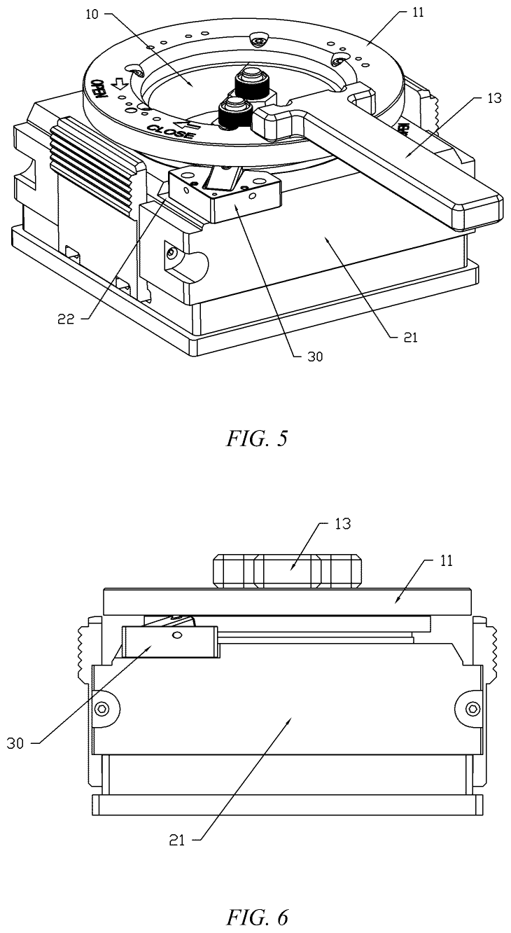

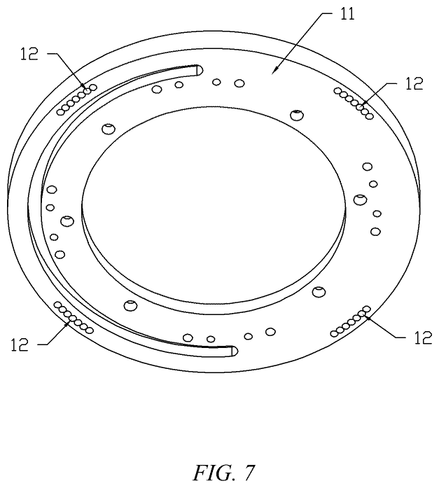

Referring to FIG. 1, this embodiment discloses a ball screw locking device 30, which adopts a rolling friction spiral to replace the sliding friction spiral, having advantages of high transmission efficiency, stable transmission, low wear, long service life, high precision, and the like, comprising: a base 31, a mounting groove 32 being provided on an upper surface of the base 31, and the base 31 being mounted on a lower connecting member 21 connected to the screw; a support rod 38, one end of which is rotatably arranged within the mounting groove 32 through pivot pin 37, elastic members 33 being arranged between support rod 38 and the bottom surface of mounting groove 32, the elastic members 33 forcing the other end of support rod 38 to project out of the upper end surface of base 31; a ball-head plunger 34, mounted at the end portion of support rod 38 that projects out of the upper end surface of base 31, wherein a ball 34a on the top of ball-head plunger 34 generates an upward supporting force through plunger spring, and the ball 34a is engaged into a locking groove 12 formed on the lower end surface of upper connecting member 11 connected to nut 10.

The elastic member 33 is at least one spring, which may be a single spring, this embodiment employs two elastic members 33 to ensure elastic member 33 provides sufficient supporting force to ball-head plunger 34.

To facilitate fixing of the springs, positioning grooves 35 are respectively provided on the end faces of the support rod 38 and the mounting groove 32 corresponding to each other, and the upper and lower ends of the elastic members 33 are respectively engaged into their corresponding positioning grooves 35. Since two springs are provided in this embodiment, two sets of positioning grooves 35 are arranged on the end surfaces of the support rod 38 and the mounting groove 32 corresponding to each other.

During movement of the ball screw locking device 30, the ball-head plunger 34 rotates together with the support rod 38, that is, the ball-head plunger 34 oscillates up and down with the support rod 38, and since the ball-head plunger 34 penetrates through the support rod 38, the bottom portion of the mounting groove 32 adjacent to the ball screw in this embodiment has a notch 36, wherein the ball-head plunger 34 is capable of moving within the notch 36.

### EMBODIMENT

A ball screw, comprising a nut 10 and a screw, wherein a plurality of rolling balls are arranged between the nut 10 and the screw, the rolling balls replacing the sliding friction spiral between the screw and the nut with a rolling friction spiral, an upper connecting member 11 being provided on the upper end surface of the nut 10, the outer side of the screw being connected to a lower connecting member 21 through positioning pins and screws, the ball locking device 30 of Embodiment 1 being arranged between the upper connecting member 11 and the lower connecting member 21, multiple sets of locking grooves 12 being provided on a lower end surface of the upper connecting member 11, each set of locking grooves 12 having multiple locking grooves 12, the multiple sets of locking grooves 12 being distributed along the circumference of the lower surface of the upper connecting member 11, the ball 34a at the top of the ball-head plunger 34 being capable of engaging into any one of the locking grooves 12, wherein the ball screw is widely applied in various industrial equipment and precision instruments. The ball screw is equipped with the ball screw locking device 30 of embodiment 1, wherein a ball locking device 30 is added near the ball screw, and through the friction force generated by contact between the ball-head plunger 34 of the ball locking device 30 and the upper connecting member 11, it prevents the ball screw from reverse rotation when the nut 10 reaches the designated position and is subjected to reverse force during use, thereby solving the problem that the ball screw cannot be locked when it reaches the designated position, and improving the safety, practicality, and convenience of the ball screw during use.

To facilitate rotation of the nut 10, the upper surface of the upper connecting member 11 in this embodiment is provided with a handle 13. When the nut 10 is rotated through the handle 13, the nut 11 can be easily turned to generate displacement, whereby the structural component transmission is smooth and the displacement accuracy is high.

Only one ball locking device 30 is provided, the lower connecting member 21 is rectangular, a limiting groove 22 is provided on the upper end surface of one corner of the lower connecting member 21, and the base 31 of the ball locking device 30 is fixedly fastened in the limiting groove 22 by means of a screw bolt 23.

The upper connecting member 11 can rotate, the nut 10 moves up and down, thereby realizing the up and down movement of the pressing head inside the lower connecting member 21. The ball locking device 30 contacts the upper connecting member 11 and generates friction force. The elastic member 33 inside the ball locking device 30 is compressed and also generates upward supporting force. After the chip testing cover reaches the working state, the nut 10 is locked, at this time the ball locking device 30 cooperates with the locking groove (12) of the upper connecting member (11), preventing the ball screw from reverse rotation, thereby improving the safety and reliability of the ball screw during use.

### INDUSTRIAL APPLICABILITY

The above embodiments are merely intended to illustrate the technical concept and characteristics of the present invention, with the purpose of enabling those skilled in the art to understand the content of the present invention and implement it accordingly, and shall not be construed as limiting the protection scope of the present invention. Any equivalent variations or modifications made in accordance with the essential spirit of the present invention shall be encompassed within the protection scope of the present invention.

1. A ball screw locking device (30), characterized in that it comprises:
a base (31), a mounting groove (32) being provided on an upper surface of the base (31), and the base (31) being mounted on a lower connecting member (21) connected to a screw;
a support rod (38), one end of which is rotatably arranged within the mounting groove (32), elastic members (33) being arranged between the support rod (38) and a bottom surface of the mounting groove (32), the elastic members (33) forcing the other end of the support rod (38) to project out of an upper end surface of said base (31);
a ball-head plunger (34), mounted at the end of the support rod (38) that projects out of the upper end surface of the base (31), wherein a ball (34a) on the top of the ball-head plunger (34) generates an upward supporting force through a plunger spring, and the ball (34a) is engaged into a locking groove (12) formed on a lower end surface of an upper connecting member (11) connected with a nut (10).

2. The ball screw locking device (30) according to claim 1, characterized in that the elastic member (33) is at least one spring.

3. The ball screw locking device (30) according to claim 1, characterized in that positioning grooves (35) are respectively provided on end surfaces of the support rod (38) and mounting groove (32) corresponding to each other, and upper and lower ends of the elastic member (33) are respectively engaged in the corresponding positioning grooves (35).

4. The ball screw locking device (30) according to claim 1, characterized in that a notch (36) is formed at a bottom portion of the mounting groove (32) adjacent to the ball screw, and the ball-head plunger (34) is movable within the notch (36).

5. A ball screw, comprising a nut (10), a screw, wherein a plurality of rolling balls are arranged between the nut (10) and the screw, characterized in that an upper connecting member (11) is provided on an upper end surface of the nut (10), a lower connecting member (21) is connected to an outer side of the screw, a ball locking device (30) according to claim 1 is arranged between the upper connecting member (11) and the lower connecting member (21), multiple sets of locking grooves (12) are provided on a lower end surface of the upper connecting member (11), the multiple sets of locking grooves (12) being distributed along the circumference of the lower surface of the upper connecting member (11), and a ball (34a) at the top of the ball-head plunger (34) is engageable into any one of the locking grooves (12).

6. The ball screw locking device (30) according to claim 5, characterized in that a handle (13) is provided on an upper end surface of the upper connecting member (11).

7. The ball screw according to claim 5, characterized in that only one ball locking device (30) is provided, the lower connecting member (21) being rectangular, a limiting groove (22) being provided on the upper end surface of one corner of the lower connecting member (21), and the base (31) of the ball locking device (30) being fixedly fastened in the limiting groove (22) by means of a screw bolt (23).
